(19) United States
(12) Patent Application Publication
(10) Pub. No.: US 2016/0133389 A1
(43) Pub. Date: May 12, 2016

(54) TANTALUM CAPACITOR AND METHOD OF MANUFACTURING THE SAME

(71) Applicant: SAMSUNG ELECTRO-MECHANICS CO., LTD., Suwon-Si (KR)

(72) Inventors: Wan Suk YANG, Suwon-Si (KR); Hong Kyu SHIN, Suwon-Si (KR); Kyoung Sup CHOI, Suwon-Si (KR)

(21) Appl. No.: 14/884,711

(22) Filed: Oct. 15, 2015

(30) Foreign Application Priority Data
Nov. 7, 2014 (KR) 10-2014-0154287

(51) Int. Cl. H01G 9/042; H01G 9/055; H01G 9/052; H01G 9/00; H01G 9/15

(52) U.S. Cl. CPC H01G 9/042; H01G 9/0029; H01G 9/15; H01G 9/0525; H01G 9/055

(57) ABSTRACT

A tantalum capacitor includes a capacitor body; a tantalum wire disposed on a surface of the capacitor body; an encapsulant part enclosing the capacitor body and the tantalum wire; an anode lead frame connected to the tantalum wire and exposed to an outer surface of the encapsulant part; and a cathode lead frame disposed on a surface of the capacitor body and exposed to the outer surface of the encapsulant part. The anode lead frame includes a pillow head part connected to the tantalum wire and an electrode plate connected to the pillow head part and exposed to the outer surface of the encapsulant part, and the pillow head part includes an etched surface.

### CROSS-REFERENCE TO RELATED APPLICATION

This application claims the benefit of priority to Korean Patent Application No. 10-2014-0154287, filed on Nov. 7, 2014 with the Korean Intellectual Property Office, the entirety of which is incorporated herein by reference.

### BACKGROUND

The present disclosure relates to a tantalum capacitor and a method of manufacturing the same.

Tantalum (Ta) is a metal widely used throughout various industrial sectors, such as the aerospace industry and the defense sector, as well as in the electrical, electronic, mechanical, and chemical fields, due to mechanical and physical properties such as a high melting point, excellent flexibility, excellent corrosion-resistance, and the like.

Since tantalum can form a stable anodized oxide film, tantalum has been widely used as a material in forming positive electrodes for small capacitors. In accordance with the rapid development of information technology (IT), information and communications technology (ICT), and electronics technology, the use of the tantalum has increased 10% on a year-on-year basis.

Generally, a capacitor is a condenser temporarily storing electricity therein, and is a component in which two flat plate electrodes, disposed in close proximity to each other, are insulated from each other when a dielectric substance is inserted therebetween, and may be charged with an electric charge due to attractive force, thereby allowing electricity to be accumulated therein. Such a capacitor stores electric charges and electric fields in a space enclosed by two conductors, and is commonly used to acquire capacitance.

A tantalum capacitor containing a tantalum material has a structure in which voids are formed at the time of sintering and curing tantalum powder. It is completed by first forming tantalum oxide (Ta₂O₅) on a tantalum surface using an anodic oxidation method, and then forming a polymer layer and a manganese dioxide (MnO₂) layer, an electrolyte, on the tantalum oxide layer acting as a dielectric substance. A carbon layer and a metal layer are then formed on the manganese dioxide layer and the polymer layer to form a body, an anode lead frame and a cathode lead frame are formed on the body for mounting on a printed circuit board (PCB), and an encapsulant part is formed.

In order to connect the tantalum wire of the tantalum capacitor to an electrode of the board on which the tantalum capacitor is mounted, the tantalum wire should be connected to the anode lead frame. Here, apart designed to allow the anode lead frame and the tantalum wire to be bonded to each other is called a pillow head, and it is manufactured by welding the electrode to the anode lead frame. As tantalum capacitor miniaturization has progressed, the defect rate occurring from the welding process has increased, as have manufacturing costs for the tantalum capacitor.

### SUMMARY

One aspect of the present disclosure may provide a tantalum capacitor capable of having a decreased defective rate, having improved characteristics, being manufactured at a reduced cost, and being miniaturized by forming an anode lead frame without performing a welding process and forming the anode lead frame and a cathode lead frame integrally with each other to simplify a manufacturing process.

According to one aspect of the present disclosure, a tantalum capacitor may comprise a capacitor body; a tantalum wire disposed on a surface of the capacitor body; an encapsulant part enclosing the capacitor body and the tantalum wire; an anode lead frame connected to the tantalum wire and exposed to an outer surface of the encapsulant part; and a cathode lead frame disposed on a surface of the capacitor body and exposed to the outer surface of the encapsulant part, wherein the anode lead frame includes a pillow head part connected to the tantalum wire and an electrode plate connected to the pillow head part and exposed to the outer surface of the encapsulant part, and the pillow head part includes an etched surface.

The side surface of the pillow head part may be the etched surface.

The side surface of the pillow head part may be inclined.

The anode lead frame and the cathode lead frame may be externally exposed to a lower surface of the tantalum capacitor.

An upper surface of the electrode plate and an upper surface of the cathode lead frame may be etched surfaces.

A thickest portion of the electrode plate and a thickest portion of the cathode lead frame may have the same thickness.

The side surfaces of the electrode plate and the cathode lead frame may be cut surfaces.

The pillow head part may have a quadrangular pillar shape.

The pillow head part may have a cylindrical shape.

According to another aspect of the present disclosure, a method of manufacturing a tantalum capacitor may comprise steps of preparing a conductive sheet; etching the conductive sheet to form a pillow head part; forming an anode lead frame including the pillow head part and a cathode lead frame by cutting and compressing the conductive sheet on which the pillow head part is formed; mounting a capacitor body on the anode lead frame and the cathode lead frame, the capacitor body having a tantalum wire disposed on a surface of the capacitor body; and forming an encapsulant part to enclose the capacitor body and the tantalum wire and externally expose surfaces of the anode lead frame and the cathode lead frame.

The step of mounting the capacitor body on the anode lead frame and the cathode lead frame may comprise bonding the pillow head part to the tantalum wire.

The method may further comprise, before the step of forming the pillow head part by the etching of the conductive sheet, a step of forming a pattern of the pillow head part on an upper surface of the conductive sheet by applying a photoresist onto the upper surface of the conductive sheet and developing the applied photoresist.

The anode lead frame and the cathode lead frame may be simultaneously formed in a single process.

Portions of the conductive sheet in which the pillow head part is not formed may be cut and compressed.

The method may further comprise attaching the cathode lead frame and the capacitor body to each other by applying a conductive adhesive to the cathode lead frame.

### BRIEF DESCRIPTION OF DRAWINGS

The above and other aspects, features and advantages of the present disclosure will be more clearly understood from the following detailed description taken in conjunction with the accompanying drawings.

FIG. 1 is a perspective view of a tantalum capacitor according to an exemplary embodiment in the present disclosure.

FIG. 2 is a cross-sectional view of the tantalum capacitor taken along line A-A′ of FIG. 1.

FIGS. 3A through 3G are views of a method of manufacturing a tantalum capacitor according to an exemplary embodiment.

FIG. 4 is a flow chart illustrating the method of manufacturing a tantalum capacitor according to an exemplary embodiment.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Tantalum Capacitor

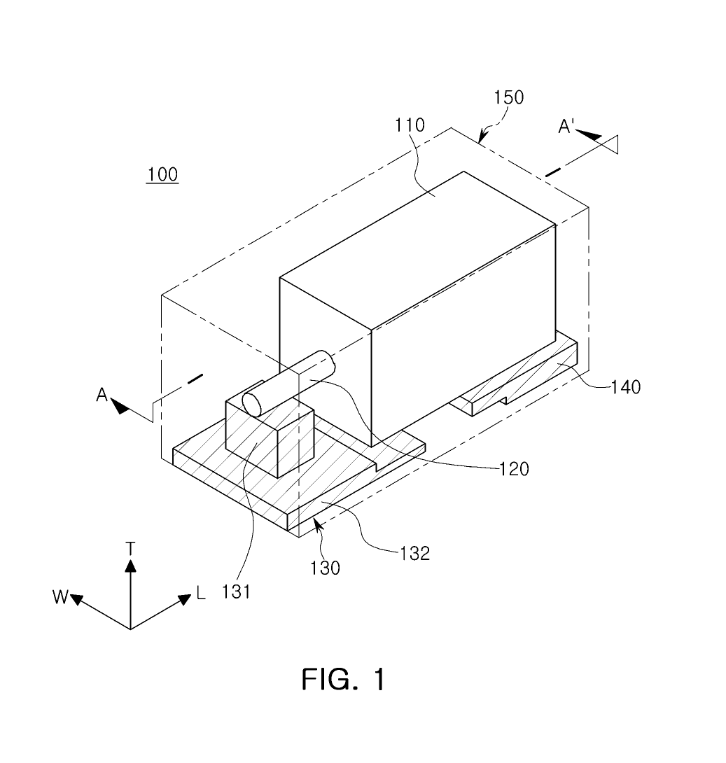

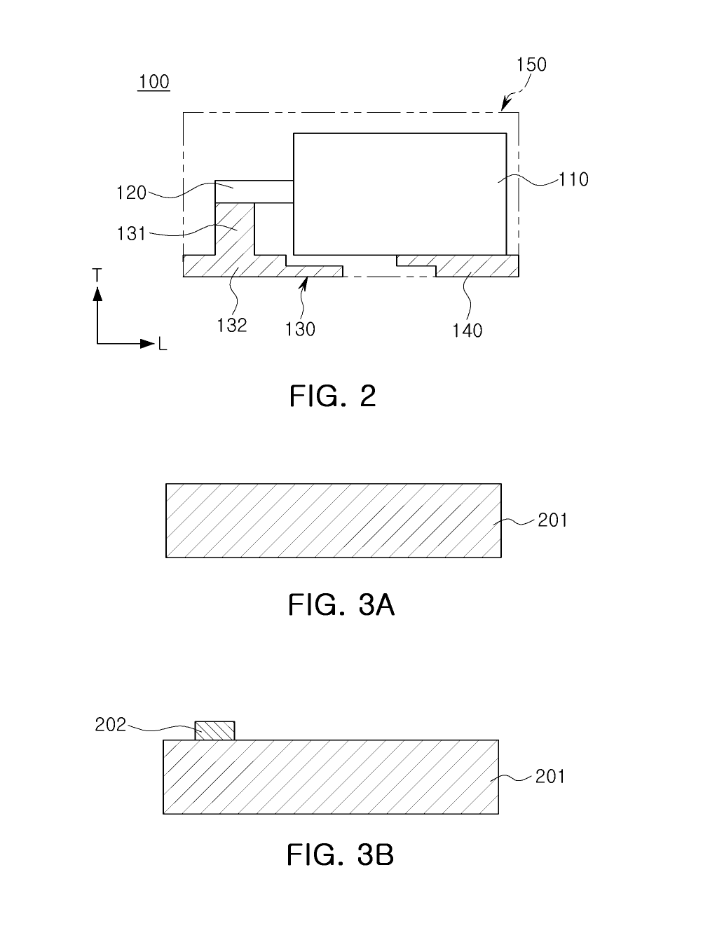

FIG. 1 is a perspective view of a tantalum capacitor 100 according to an exemplary embodiment in the present disclosure; and FIG. 2 is a cross-sectional view of the tantalum capacitor 100 taken along line A-A′ of FIG. 1. In FIGS. 1 and 2, a length direction L, a width direction W, and a thickness direction T of the tantalum capacitor 100 are defined. Therefore, the tantalum capacitor 100 according to an exemplary embodiment will be described.

Referring to FIGS. 1 and 2, the tantalum capacitor 100 may include a capacitor body 110, a tantalum wire 120 disposed on one surface of the capacitor body 110, an encapsulant part 150 disposed to enclose the capacitor body 110 and the tantalum wire 120, an anode lead frame 130 connected to the tantalum wire 120 and exposed to one surface of the encapsulant part 150, and a cathode lead frame 140 disposed on one surface of the capacitor body 110 and exposed to one surface of the encapsulant part 150. Here, the anode lead frame 130 may include a pillow head part 131 connected to the tantalum wire 120 and an electrode plate 132 connected to the pillow head part 131 and exposed to one surface of the encapsulant part 150. The pillow head part 131 may include etched surfaces.

The capacitor body 110 may be formed of tantalum. For example, the capacitor body 110 may be manufactured by mixing tantalum powder and a binder at a predetermined ratio, agitating the mixture of the tantalum powder and the binder, compressing the mixed powder of the tantalum powder and the binder to form a rectangular parallelepiped, and sintering the rectangular parallelepiped at a high temperature and high vibrations.

The tantalum wire 120 may be disposed on one surface of the capacitor body 110. Referring to FIGS. 1 and 2, the tantalum wire 120 may be disposed on one end surface of the capacitor body 110 in the length direction. However, a position of the tantalum wire 120 is not limited thereto.

The tantalum wire 120 may be inserted into and mounted in the mixtures of the tantalum powders and the binders before the mixed powders of the tantalum powders and the binders are compressed. For instance, the capacitor body 110 may be manufactured by inserting the tantalum wire 120 into the tantalum powders with which the binder is mixed, forming a tantalum element having a desired size, and then sintering the tantalum element at a temperature of about 1,000° C. to 2,000° C. under a high-vacuum atmosphere (10⁻⁵ torr or less) for about 30 minutes.

The tantalum wire 120 may be connected to the anode lead frame 130. The anode lead frame 130 may include the pillow head part 131 connected to the tantalum wire 120 and the electrode plate 132 connected to the pillow head part 131 and externally exposed from the encapsulant part 150. The electrode plate 132 may be connected to an external power supply to allow for current flow to the tantalum wire 120 through the pillow head part 131. For instance, the anode lead frame 130 may be exposed to one surface of the encapsulant part 150 and be used as a connection terminal for electrical connection to another electronic product. To this end, the anode lead frame 130 may be formed of a conductive metal such as a nickel-iron alloy, or the like.

The capacitor body 110 may be connected to the cathode lead frame 140. The cathode lead frame 140 may be spaced apart from the anode lead frame 130 and the tantalum wire 120. The cathode lead frame 140 may be partially externally exposed from the encapsulant part 150 and may be used as a connection terminal for electrical connection to another electronic product. The cathode lead frame 140 may be formed of a conductive metal such as a nickel-iron alloy, or the like. The anode lead frame 130 and the cathode lead frame 140 may be disposed in parallel with each other to be spaced apart from each other.

Referring to FIGS. 1 and 2, the anode lead frame 130 and the cathode lead frame 140 may be disposed on a lower surface of the capacitor body 110 and be disposed to be exposed to a lower surface of the tantalum capacitor 100.

If the anode lead frame and the cathode lead frame are exposed to side surfaces of the tantalum capacitor, the anode lead frame and the cathode lead frame may need to be bent in order to form electrodes. Therefore, regions occupied by the anode lead frame and the cathode lead frame within the encapsulant part 150 may be large, such that a region occupied by the capacitor body may become relatively small. As a result, capacitance of the tantalum capacitor may be decreased.

Conversely, in a case in which the anode lead frame 130 and the cathode lead frame 140 are disposed on the lower surface of the tantalum capacitor 100, regions occupied by the anode lead frame 130 and the cathode lead frame 140 within the encapsulant part 150 may become small, such that a region occupied by the capacitor body 110 may become large. Therefore, the tantalum capacitor 100 having a high capacitance may be manufactured.

The anode lead frame 130 may include the pillow head part 131. Since the tantalum wire 120 is disposed to protrude on a side surface of the capacitor body 110, the tantalum wire 120 may be disposed to be spaced apart from an outer surface of the tantalum capacitor 100 by a predetermined distance. Therefore, since the anode lead frame 130 needs to be connected to the tantalum wire 120 while being exposed to the outer surface of the tantalum capacitor 100, the anode lead frame 130 may include the pillow head part 131.

An anode lead frame of a tantalum capacitor, according to the related art, may be generally formed by cutting and compressing a conductive sheet to form an electrode plate and bonding a separately manufactured pillow head part onto an upper surface of the electrode plate by a separate welding process. Since the separate welding process is performed, the manufacturing process may be complicated, and manufacturing costs may be high. In addition, the anode lead frame of the tantalum capacitor, according to the related art, has a range of problems. First, it is difficult to accurately fix the pillow head part to a specific position on the upper surface of the electrode plate for the purpose of welding. Second, short circuits may be generated due to application of a welding material, or the like. Third, the pillow head part may be welded in a state in which it is inclined due to the welding material, or the like. Fourth, since the pillow head part needs to be miniaturized in accordance with miniaturization of the tantalum capacitor, it is difficult to bond the miniaturized pillow head part by the welding process.

In the anode lead frame 130 of the tantalum capacitor 100 according to an exemplary embodiment, the pillow head part 131 may be formed by etching the conductive sheet. Since the pillow head part 131 is connected integrally with the electrode plate 132 of the anode lead frame 130, a separate welding process may not be required. Therefore, a manufacturing process may be simple, and manufacturing costs may be reduced. In addition, the defects due to the welding process described above may not be generated, and a tantalum capacitor 100 having a small size may be manufactured.

The conductive sheet, which is a material forming the anode lead frame 130 and the cathode lead frame 140, may be formed of a conductive metal such as a nickel-iron alloy, or the like. Remaining portions of the conductive sheet except for the pillow head part 131 may be partially etched and removed. Side surfaces of the pillow head part 131 may be the etched surfaces. For instance, the side surfaces of the pillow head part 131 may be inclined. A cross-sectional area of an upper surface of the pillow head part 131, which is a portion of the pillow head part 131 connected to the tantalum wire 120, may be wider than that of a lower surface of the pillow head part 131, which is a portion of the pillow head part 131 connected to the electrode plate 132. Therefore, the pillow head part 131 may have a width that becomes narrow from an upper portion thereof toward a lower portion thereof, such that the side surfaces of the pillow head part 131 may be inclined.

After the pillow head part 131 is formed as described above, the electrode plate 132 of the anode lead frame 130 and the cathode lead frame 140 may be formed by cutting and compressing processes. Upper surfaces of the electrode plate 132 and the cathode lead frame 140 may be portions etched at the time of performing an etching process for forming the pillow head part 131. Therefore, the upper surfaces of the electrode plate 132 and the cathode lead frame 140 may be etched surfaces. In addition, side surfaces of the electrode plates 132 of the anode lead frame 130 and the cathode lead frame 140 may be cut by a cutting process. Therefore, the side surfaces of the electrode plate 132 and the cathode lead frame 140 may be cut surfaces.

Since portions of the conductive sheet in upper portions of the electrode plate 132 of the anode lead frame 130 and the cathode lead frame 140 are removed by the same etching process, thicknesses of the electrode plate 132 of the anode lead frame 130 and the cathode lead frame 140 may be identical. However, partial regions may be compressed by the compressing process or cut by the cutting process, if necessary, after the etching process. Therefore, thicknesses of portions except for portions compressed by the compressing process or cut by the cutting process may be identical. For instance, a thickness of the thickest portion in the electrode plate 132 and a thickness of the thickest portion in the cathode lead frame 140 may be identical.

Referring to FIG. 1, the pillow head part 131 may have a quadrangular pillar shape. However, the pillow head part 131 is not limited thereto, and may have various shapes such as a cylindrical shape or a triangular pillar shape.

The tantalum capacitor 100 may further include an adhesive in order to bond the cathode lead frame 140 and the capacitor body 110 to each other. The adhesive disposed between the cathode lead frame 140 and the capacitor body 110 may be an adhesive containing an epoxy-based thermosetting resin. However, the adhesive, according to the present disclosure, is not limited thereto.

The capacitor body 110 and the tantalum wire 120 may be enclosed by the encapsulant part 150. Partial regions of the pillow head part 131 and the electrode plate 132 of the anode lead frame 130 and a partial region of the cathode lead frame 140 may also be positioned in the encapsulant part 150. Some surfaces of the electrode plate 132 of the anode lead frame 130 and the cathode lead frame 140 may be externally exposed from the encapsulant part 150.

The encapsulant part 150 may be formed by transfer-molding a resin such as an epoxy molding compound (EMC), or the like.

The encapsulant part 150 may not only serve to protect the tantalum wire 120 and the capacitor body 110 from external factors, but may also serve to insulate the capacitor body 110 and the anode lead frame 130 from each other.

Method of Manufacturing Tantalum Capacitor

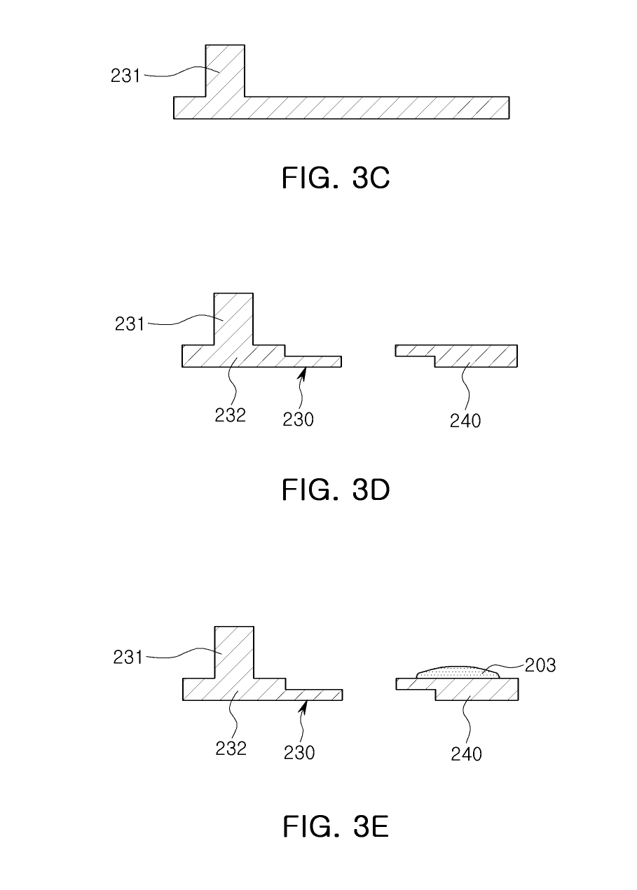

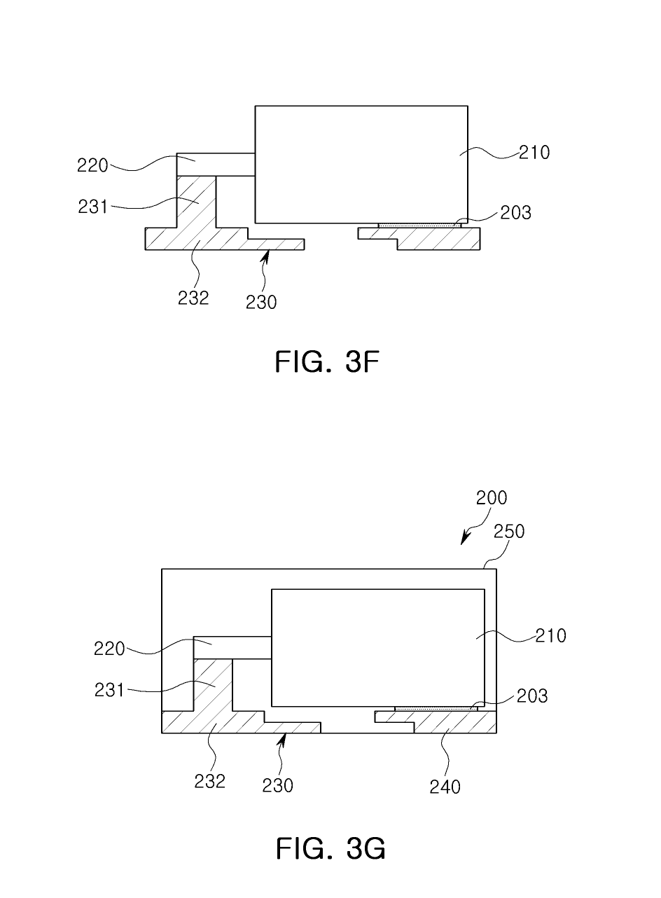

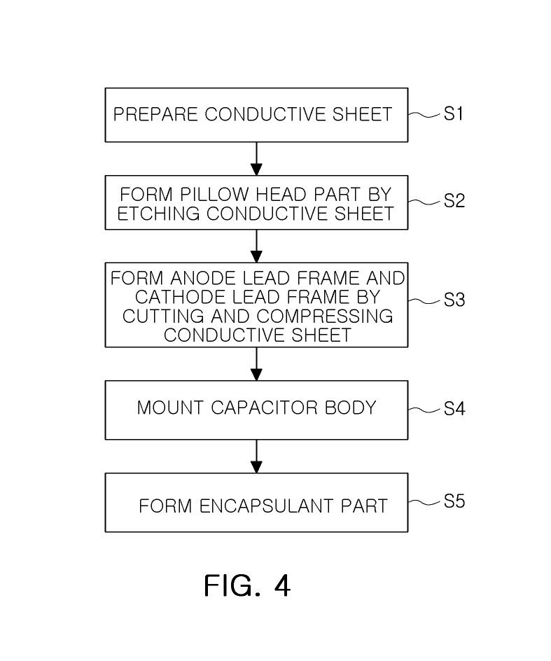

FIGS. 3A through 3G are views of a method of manufacturing a tantalum capacitor 200 according to an exemplary embodiment; and FIG. 4 is a flow chart illustrating the method of manufacturing a tantalum capacitor 200 according to an exemplary embodiment.

Referring to FIGS. 3A through 3G, the method of manufacturing a tantalum capacitor 200, according to an exemplary embodiment, may include preparing a conductive sheet 201 (S1), forming a pillow head part 231 by etching the conductive sheet (S2), forming an anode lead frame 230 including the pillow head part 231 and a cathode lead frame 240 by cutting and compressing the conductive sheet on which the pillow head part 231 is formed (S3), mounting a capacitor body 210 on upper surfaces of the anode lead frame 230 and the cathode lead frame 240 (S4), the capacitor body 210 having a tantalum wire 220 disposed on one surface thereof, and forming an encapsulant part 250 to enclose the capacitor body 210 and the tantalum wire 220 and externally expose one surface of each the anode lead frame 230 and the cathode lead frame 240 (S5).

FIG. 3A illustrates the conductive sheet 201, which is a material for manufacturing the anode lead frame 230 and the cathode lead frame 240 (S1). The conductive sheet 201 may be formed of a conductive metal such as a nickel-iron alloy, or the like.

Next, the conductive sheet 201 may be etched to form the pillow head part 231 (S2). FIG. 3B illustrates that a photoresist pattern 202 corresponding to a pattern of the pillow head part 231 is formed on the conductive sheet 201. After a photoresist is deposited on the conductive sheet 201, a mask for forming the pattern of the pillow head part on which the photoresist is deposited may be arranged, and an exposure process may be performed. Then, the conductive sheet 201 to which the exposed photoresist is applied may be immersed in a developer to form the photoresist pattern 202 corresponding to the pattern of the pillow head part 231. The conductive sheet 201 on which the photoresist pattern 202 is formed may be etched to remove portions of the conductive sheet 201 to which the photoresist pattern 202 is not applied. Here, an etchant, an etching process time, and the like, may be adjusted to adjust an etching amount of etched portions, thereby minutely adjusting a height of the pillow head part 231. When the etching process is completed, portions in which the pillow head part 231 is not formed may be removed, such that the pillow head part 231 may be derived and formed, as illustrated in FIG. 3C.

Next, as illustrated in FIG. 3D, the conductive sheet on which the pillow head part 231 is formed may be cut and compressed to form the anode lead frame 230 including the pillow head part 231, and the cathode lead frame 240 (S3). The anode lead frame 230 and the cathode lead frame 240 may be cut to an appropriate length in consideration of a size of the capacitor body 210 that is to be mounted thereon and a size of the tantalum capacitor 200. In addition, a special shape may be compressed and formed on mounted surfaces of the anode lead frame 230 and the cathode lead frame 240 in order to increase adhesion strength between the anode lead frame 230 and the cathode lead frame 240 and the capacitor body 210, and grooves may be formed in the anode lead frame 230 and the cathode lead frame 240 in order to improve strength of the anode lead frame 230 and the cathode lead frame 240. The cutting and compressing processes may be performed on regions in which the pillow head part 231 is not formed. The cutting and compressing processes may be simultaneously performed to form the anode lead frame 230 and the cathode lead frame 240. Therefore, the processes may be simplified, and manufacturing costs may be reduced.

Next, the capacitor body 210 having the tantalum wire 220 disposed on one surface thereof may be mounted on the upper surfaces of the anode lead frame 230 and the cathode lead frame 240 (S4). The anode lead frame 230 and the cathode lead frame 240 may be disposed in parallel with each other. Here, heat resistant tape may be attached onto lower surfaces of the anode lead frame 230 and the cathode lead frame 240 to be connected to each other. The heat resistant tape may prevent surfaces of the anode lead frame 230 and the cathode lead frame 240 from being polluted in a molding process that is later performed.

When the capacitor body 210 is mounted on an upper surface of a front end portion of the cathode lead frame 240 and the tantalum wire 220 of the capacitor body 210 contacts the pillow head part 231 of the anode lead frame 230, the tantalum wire 220 and the pillow head part 231 may be electrically attached to each other by performing spot-welding, laser-welding, or by applying a conducive adhesive. Here, as illustrated in FIG. 3E, before the capacitor body 210 is mounted, the conductive adhesive may be applied to a mounted part of the cathode lead frame 240 to form a conductive adhesive layer 203 having a predetermined thickness, thereby improving adhesion strength between the cathode lead frame 240 and the capacitor body 210. Then, a process of hardening the conductive adhesive layer 203 at a temperature of about 100° C. to 200° C. may be performed in order to harden the conductive adhesive layer 203. FIG. 3F illustrates an embodiment where the capacitor body 210 is mounted on the anode lead frame 230 and the cathode lead frame 240.

Next, as illustrated in FIG. 3G, the encapsulant part 250 may enclose the capacitor body 210 and the tantalum wire 220 and externally expose one surface of each the anode lead frame 230 and the cathode lead frame 240 (S5). The encapsulant part 250 may serve to protect the tantalum wire 220 and the capacitor body 210 from external factors.

When the encapsulant part 250 is formed, the heat resistant tape attached to the lower surfaces of the anode lead frame 230 and the cathode lead frame 240 may be removed.

The tantalum capacitor 200 may be manufactured through the above-mentioned process.

As set forth above, in the tantalum capacitor, according to exemplary embodiments, the anode lead frame is formed without performing a welding process, and the anode lead frame and the cathode lead frame are formed integrally with each other to simplify a manufacturing process, whereby a defect rate may be decreased, product characteristics may be improved, manufacturing costs may be decreased, and a product may be miniaturized.

While exemplary embodiments have been shown and described above, it will be apparent to those skilled in the art that modifications and variations could be made without departing from the scope of the present invention as defined by the appended claims.

What is claimed is:

1. A tantalum capacitor comprising:
a capacitor body;
a tantalum wire disposed on a surface of the capacitor body;
an encapsulant part enclosing the capacitor body and the tantalum wire;
an anode lead frame connected to the tantalum wire and exposed to an outer surface of the encapsulant part; and
a cathode lead frame disposed on a surface of the capacitor body and exposed to the outer surface of the encapsulant part,
wherein the anode lead frame includes a pillow head part connected to the tantalum wire and an electrode plate connected to the pillow head part and exposed to the outer surface of the encapsulant part, and
the pillow head part includes an etched surface.

2. The tantalum capacitor of claim 1, wherein a side surface of the pillow head part is the etched surface.

3. The tantalum capacitor of claim 1, wherein the side surface of the pillow head part is inclined.

4. The tantalum capacitor of claim 1, wherein the anode lead frame and the cathode lead frame are externally exposed to a lower surface of the tantalum capacitor.

5. The tantalum capacitor of claim 1, wherein an upper surface of the electrode plate and an upper surface of the cathode lead frame are etched surfaces.

6. The tantalum capacitor of claim 1, wherein a thickest portion of the electrode plate and a thickest portion of the cathode lead frame have the same thickness.

7. The tantalum capacitor of claim 1, wherein side surfaces of the electrode plate and the cathode lead frame are cut surfaces.

8. The tantalum capacitor of claim 1, wherein the pillow head part has a quadrangular pillar shape.

9. The tantalum capacitor of claim 1, wherein the pillow head part has a cylindrical shape.

10. A method of manufacturing a tantalum capacitor, comprising steps of:
preparing a conductive sheet;
etching the conductive sheet to form a pillow head part;
forming an anode lead frame including the pillow head part and a cathode lead frame by cutting and compressing the conductive sheet on which the pillow head part is formed;
mounting a capacitor body on the anode lead frame and the cathode lead frame, the capacitor body having a tantalum wire disposed on a surface of the capacitor body; and
forming an encapsulant part to enclose the capacitor body and the tantalum wire and externally expose surfaces of the anode lead frame and the cathode lead frame.

11. The method of manufacturing a tantalum capacitor of claim 10, wherein the step of mounting the capacitor body on the anode lead frame and the cathode lead frame comprises bonding the pillow head part to the tantalum wire.

12. The method of manufacturing a tantalum capacitor of claim 10, further comprising, before the step of forming the pillow head part by the etching of the conductive sheet, a step of forming a pattern of the pillow head part on an upper surface of the conductive sheet by applying a photoresist onto the upper surface of the conductive sheet and developing the applied photoresist.

13. The method of manufacturing a tantalum capacitor of claim 10, wherein in the step of forming the anode lead frame including the pillow head part and the cathode lead frame by the cutting and the compressing of the conductive sheet on which the pillow head part is formed, the anode lead frame and the cathode lead frame are simultaneously formed in a single process.

14. The method of manufacturing a tantalum capacitor of claim 10, wherein in the step of forming the anode lead frame including the pillow head part and the cathode lead frame by the cutting and the compressing of the conductive sheet on which the pillow head part is formed, portions of the conductive sheet in which the pillow head part is not formed are cut and compressed.

15. The method of manufacturing a tantalum capacitor of claim 10, wherein the step of mounting the capacitor body on the anode lead frame and the cathode lead frame further comprises attaching the cathode lead frame and the capacitor body to each other by applying a conductive adhesive to the cathode lead frame.
